(19) United States
(12) Patent Application Publication
(10) Pub. No.: US 2005/0033657 A1
(43) Pub. Date: Feb. 10, 2005

(54) Personalized content management and presentation systems

(75) Inventors: Douglas J. Herrington, Palo Alto, CA (US); Eva Manolis, Menlo Park, CA (US); Patrick R. Wright, Mountain View, CA (US); Daniel J. Climan, San Francisco, CA (US); Hwei M. Quek, Cupertino, CA (US)

Correspondence Address: WILSON SONSINI GOODRICH & ROSATI, 650 PAGE MILL ROAD, PALO ALTO, CA, 943041050, US

(73) Assignee: KeepMedia, Inc., a Delaware Corporation, Redwood Shores, CA (US)

(21) Appl. No.: 10/897,581

(22) Filed: Jul. 23, 2004

Related U.S. Application Data
(60) Provisional application No. 60/490,011, filed on Jul. 25, 2003.

(51) Int. Cl. G06F 17/60

(52) U.S. Cl. 705/26

(57) ABSTRACT

A graphical user interface for presenting media content having a series of representative pictorial images corresponding to various selected media publications. The interface further includes a metaphorical graphical representation of a rack shown as supporting the pictorial or thumbnail images of the media publications. Upon selection of a desired pictorial image, the selected pictorial image is brought to the forefront of the graphical rack representation to simulate taking a selected media publication off-the-rack. A series of content links are then presented to a user corresponding to the content of interest contained in the selected media publication. The user may click-on and select a content link allowing the user to browse through contents of the selected media publication. In addition, various methods are also provided for presenting electronically stored media content by visually depicting selected publications resting on a graphical rack representation as if arranged in a retail-store type display. Users click-on a publication bringing it to the forefront of the superimposed graphical rack representation to simulate taking a selected magazine or magazine off-the-rack for browsing.

### CROSS REFERENCE TO RELATED APPLICATION

This application claims the benefit of and priority to U.S. Provisional Patent Application Ser. No. 60/490,011 filed Jul. 25, 2003, which is incorporated herein by reference in its entirety.

### FIELD OF THE INVENTION

The invention relates to systems and methods for distributing digital media content. More particularly, the invention relates to the personalized management and presentation of media content including magazines and other newsstand publications.

### BACKGROUND

Many publishers today remain dependent on traditional printed medium for the distribution of content. These content providers disseminate information through magazines, newspapers, books and other widely used publications in the traditional paper format. In addition to utilizing limited paper resources to manufacture these products, the geographical distribution of books, magazines and newspapers consumes other resources as well. These additional expenses include transportation costs, shipping and handling. Oftentimes readers unfortunately discard these publications even without reading them, and can not readily retrieve prior issues should a need for them arise in the future. At the same time, publishers are often unable to capitalize on potential revenue generated from user review of prior or archived publications. Accordingly, from both the readers and publishers perspectives, there is a lost opportunity when individuals are not able to easily access older issues or editions of various media content.

Despite the Internet bubble burst several years ago, the online paid content market is large and growing. Some recent studies concluded that one of every nine Internet users use a credit card to pay for viewing online content. Moreover, about half the estimated consumer spending of $2 billion can be attributed to what may be defined as “text info” services. The market for premium content continues to grow rapidly, in particular. Larger consumer trends are believed to be driving this market growth. Recent studies indicate that the vast majority of consumers have Internet access and are spending more than an hour and a half per day online. For many experienced users, the Internet has become their most important source of news, information, and entertainment. The time spent by consumers with Internet access at work is surpassing the time spent with any other single media during the workweek.

As Internet usage has increased, so has consumer frustration with quality and convenience. Although many consumers rank the Internet higher than TV, newspapers, or magazines as an important source of information, low marks are given for the overall quality and reliability of the information offered. This problem continues to worsen as quality-blind search engine crawlers race to index more pages of the Internet, inevitably adding higher ratios of content that is biased, inaccurate, unreadable, and/or offensive. This relatively low “signal-to-noise” ratio generated by the number of free search engines today is actually driving the market for an increasing numbers of consumers willing to pay for higher quality content and convenience.

Individual mainstream publishers are increasingly choosing to offer their content via paid models over the Internet. Realizing that online advertising alone could not often pay for the building and operating of content-rich websites, an increasing number have migrated to pay-for-content systems. For example, most large newspapers offer their archives on a pay-per-item basis. With respect to consumer magazines, the majority of publishers do not even offer any significant amount of their content online. As for the few that provide this content, most hide some or all of their content behind a subscription or pay-per-item pay wall. This piecemeal approach to content retailing, where each publisher tries to build their own store online has ultimately limited the growth of the relevant market. In a world where each publisher creates their own unique models on their own sites, consumers are not offered much convenience. It is difficult for consumers to find the content they want—free search engines can not effectively index the premium content offered by mainstream publishers, and most consumers do not have time to visit and search multiple sites. Even when content is found to be of interest, the per-item pricing models and the price/value ratio offered today by most individual publisher sites is often times just not particularly attractive to consumers.

Others in the past attempted to aggregate and resell content to consumers with limited results. Previous content providers simply offered the wrong price apparently to consumers since high per-item pricing was the traditional approach to selling content retail. For example, a $2.95 per article price-point was typical at individual sites such as Newsweek or US News & World Report, or at content aggregation sites such as Contentville and Northern Light. This pricing model tends to discourage significant consumer usage. Business aggregators such as LexisNexis and Factiva however do offer subscription pricing, but their $250+per month price points are generally suitable only for professional information researchers. Moreover, content providers in the past appeared to offer the wrong mix of content. Many consumer-oriented aggregation sites do not offer an attractive enough mix of content within their “walled garden.” The concept of “more” is again not the same thing as “better” with respect to sites that offer large volumes of non-premium content. For example, Highbeam Research mixed-in obscure titles and free unqualified search results. Contentville included both professional and amateur content. In both instances, the consumer was asked to either settle-for or pick-through lower quality merchandise to get to the premium, branded content. Online content providers in the past also seemingly offered the wrong type of service. Most services to date are designed with the professional data researcher in mind, rather than the consumer. They tend to have relatively complicated search interfaces, limited browsing tools, primitive customization, and unattractive content presentation. While these limitations may be acceptable for professional researchers with a firm grasp of Boolean search commands, these online content providers fail to meet the minimum service requirements for most users. Consumers are just not willing to work so hard to view content online.

As the popularity and growth of the Internet continues to increase, many publishers are still looking for an effective way to distribute their publications for viewing online. But there lacks a consistent and personalized solution to present this information to consumers. There is a need for an efficient and customizable system that allows viewers to access a rich source of media content online from a single platform.

### SUMMARY OF INVENTION

The invention provides systems and methods for managing and presenting personalized digital media content. Various aspects of the invention can be appreciated individually or collectively to provide efficient personalized content management and presentation systems.

A variety of customizable platforms are provided in accordance with the invention. From a single convenient access point, individual users can easily access and consume, share and organize a wide variety of digital content from numerous content providers across a network such as the Internet. With a personalized graphical user interface, the particular user may accomplish a variety of tasks with selected digital content such as viewing or reading, printing, emailing, organizing and storing such information as described further herein. The invention provides personalized platforms (e.g., KeepMedia website) that allows a user to easily access, consume, share and organize a wide variety of content from numerous content providers, all from a single access point.

The invention further provides media platforms and websites for consumers to find and buy the content they want for information, entertainment, learning, and a sense of community. The personalized content management and presentation systems herein can be designed with the following consumer considerations in mind:

Premium Content. The content provided can be selected from branded, professionally created content from leading publishers that offers broad topical coverage such as that found at a newsstand today. A consumer can also access both current and archived content giving consumers the opportunity to both “stay current” and “go deep” into topics or publications of interest.

Premium Service. The content can be offered through a single location such as the KeepMedia website. This provides convenient one-stop-shopping for consumers through an easy-to-use user interface. The presentation systems herein offer advanced tools to both search and browse, and in addition, the personalized content management tools provided also allow consumers to find and enjoy the content that interests them most. During the course of browsing through content that is intuitively presented on graphical racks and pages described herein, users can enjoy their favorite articles while conveniently keeping, printing, and/or sharing them too. At the same time, users can find new favorite content items while conveniently tracking certain topics or being offered suggested or related articles. This provides convenient packaging of topically interesting and relevant issues, peoples and events via Featured News, Featured Topics, and Week-In-Review. Alternative embodiments of the invention may further comprise extensions of the content media platforms provided herein that include community-type features such as: (i) interactive chats or chat rooms; (ii) hosted presentations by selected author(s) or publication(s); and (iii) topically oriented message boards.

Premium Pricing. The content can be offered based on low-priced online subscription rates. At the same time, competitive a-la-carte pricing for premium items and print versions/subscriptions can be provided. As media platform offerings expand, the relevant pricing model can grow to accommodate it. Similar to the pricing structure followed by the cable-business, providers can offer a rich base subscription package. Moreover, they can add premium subscription packages, as well as an almost unlimited number of a-la-carte premium items. Media platforms described herein such as the KeepMedia website can offer hundreds of premium publications and nationally branded magazine and newspaper such as Newsweek, USA TODAY, U.S. News and World Report, BusinessWeek, Forbes, Psychology Today, Esquire, The Atlantic, Family Circle, PC Magazine and Variety. Online access to all of these publications can be provided to consumers for predetermined flat-fees or the single monthly subscription rate, e.g., $4.95 per month. This single subscription allows consumers to “stay current” with hundreds of new articles a day from daily publishers such as USA TODAY, OpinionJournal, AFP, HealthDay and Knight Ridder, and to “go deep” with unlimited access to the up-to-date archives of all accessible publications. The media platforms herein can thus sell print subscriptions as well as online access to premium content on an a-la-carte basis.

Another exemplary embodiment of the invention provides personalized content management and presentation systems. These systems may include separate system components that perform up to five (5) main processes or more within the selected platform including but not limited to the following: content management, personalization functionality, content presentation and interaction, syndication platform for distributing content to external partners; and contextual presentation of premium items. These processes can be selected and designed to offer closely related functionality and inter-dependence as further described herein.

Various aspects of the invention may be implemented by online media retailers that want to offer consumers convenient and personalized access to quality, branded content. The storefront is online which allows customers to purchase and access content through standard Internet browsers or Web access devices. Such retailers can partner with leading magazines and newspaper publishers to sell online access and print subscriptions to over a wide variety of leading publications. Consumers can thereby search, browse, keep, and share articles and content from these quality brand publications on a single or convenient site for a single low subscription price or other fee according to a predetermined revenue model.

Furthermore, the basic services provided in accordance with the invention include access to both current real-time news and up-to-date magazine archives. Consumers can buy related premium items and print subscriptions as well. This serves the premium content market and the expanding base of Internet users willing to pay for easier access to better content online. For publishers, a low-cost, low-risk, brand-enhancing marketplace can be created with the invention. The media platforms and websites constructed in accordance with the invention can be flexibly modified to offer a plug-and-play solution for the paid-content needs of each publisher. These technical platforms generate a high-traffic marketplace, and a set of consumer friendly services and features that individual publishers could not readily achieve on their own.

While the systems and methods herein can be preferably modified to offer and sell magazine and newspaper content, it shall be understood that principles of the invention can be scalable and expanded to include more and other types of media, including books, hosted chats, message boards/community forums, audio, and video. Moving beyond periodicals, there are literally thousands of potential premium items to make available on media platforms provided herein. Some examples include related “special reports,” databases, photo archives, or books. And beyond text and photos, rich-media offers additional expansion opportunities with spoken audio, video and eventually music and movies. All of these items can be seamlessly added to the retail environments created in accordance with the invention. They can be contextually and personally merchandised to consumers based on or related to what other content they read and enjoy.

Another embodiment of the invention provides syndication systems for distributing content to external partners. These syndication systems create a number of available marketing channels for media platform hosts. Features of the syndication systems provided herein include the following:

Free Search Engines. A series of dedicated servers can allow search-engine bots to crawl and index the full breadth of content available on a website such as the KeepMedia site.

Search Engine Advertising. Any number of terms can be purchased across major search ads services. These can drive back to search results and featured topics found on the content retailer website such as the KeepMedia site.

Paid Inclusion/Integrated Search. The hosts of media platforms herein can direct XML feeds of the content and/or a direct search API to other search engine operators. On a pay-per-click or revenue share basis, search engine operators can be paid for traffic, trials, and subscriptions resulting from the results.

Related Article Marketing. Affiliate partners can be provided an easy-to-publish box of automatically generated related articles. This box can be placed on topic pages or individual articles. Affiliate partners earn a bounty on the traffic, trials, and subscriptions generated on their site.

Viral Activities. The sharing of content can be actively encouraged to help drive awareness and trial of content services. For example, a “Featured News” RSS feed can be provided to bloggers for complimentary story postings on their weblogs.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### BRIEF DESCRIPTION OF THE FIGURES

FIG. 1 is an illustrative overview describing the processing and flow of content in the personalized content management and presentation systems provided herein.

FIG. 2 is a flow diagram illustrating content pre-preprocessing and processing steps for content received from various media content partners before presentation and distribution.

FIG. 3 describes the flow of media content that can be personalized within a content management and presentation system.

FIGS. 4-13 provide screenshots of various graphical user interfaces and portions thereof from the personalized content management and presentation systems provided in accordance with the invention.

FIG. 14 describes the editorial process for a content management system connected to content databases and a customer related database that personalizes the content delivered and presented to users.

FIG. 15 is a flowchart describing the flow of content within a content syndication system for distributing content to a network of partners.

FIG. 16 illustrates a targeted advertisement engine that presents processed items to users based on data from a customer database.

### DETAILED DESCRIPTION OF INVENTION

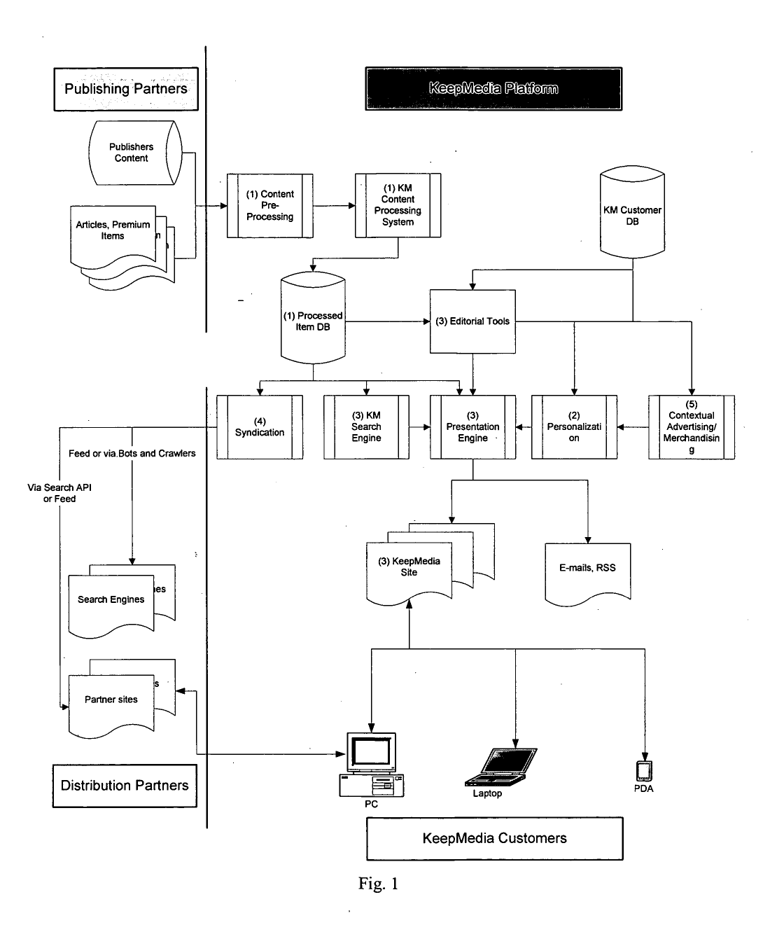

As shown in FIG. 1, the content management process and workflow begins with the introduction of content from a variety of publishers in accordance with this aspect of the invention. A wide network of media content providers may be initially established to offer a range of information to be distributed including publications such as BusinessWeek, Newsweek and USA TODAY. These partners can offer distributed content including regularly scheduled content from publishers that cover a typical range of selected interests or news items. In addition, depending upon the relationship with publishing partners, selected feature articles and premium items may be separately offered by these partners occasionally or from time to time. Because the personalized content management and personalization systems herein do not require incoming media content to arrive according to fixed methods and formats, the media platforms provided herein accepts incoming feeds from a variety of content providers in a variety of content formats. A group of one or more highly automated, configurable custom content processors may be selected for each provider feed. The raw content received can be passed through a series of pre-processing and processing procedures established ahead of time according to selected standards or requirements as determined by the media host and content or syndication partners. These processes may include various content modifications and editing described in greater detail herein such as automated categorization, indexing and creation of content summaries arranged according to provider. At the same time, the content management systems herein may include a database of customer information which enables the delivery of customer specific or directed content to targeted audiences. The directed content can include merchandising blocks of cross-merchandized items that can be presented to the user: The personalization functionality herein can be expanded to allow cross-merchandising of items that may be of interest a specific user based on content are viewing or have viewed in the past. The personalized content may be thus presented in accordance with predetermined preferences established by users following any editorial modifications which may be performed beforehand. Accordingly, the processed and personalized content may be presented in accordance with the systems and methods provided herein to a network of content distribution partners and a subscriber or customer base.

Personalized Notifications

The media platforms provided herein also offer emails and RSS feeds which allow hosts to actively communicate with its subscribers and users beyond the website itself. The user and a host such as KeepMedia can control the frequency with which these personalized notifications are delivered. At the same time, specific areas of personalization and types of content can be also selected beforehand. These personalized updates can be preferably or primarily delivered to a user designated PC, laptop or desktop computer. Other embodiments of the invention offer delivery of these email notifications and information in delivery formats that can be accessed and viewed from alternative user interfaces on wireless and personal communication devices such as personal digital assistants (PDAs), Instant Messenger (IM) platforms and cell phones.

The following are illustrative examples of what kinds of emails and RSS could be received by a user from the KeepMedia platform. It shall be understood however that the invention also provides notifications on other types of media platforms and is not limited only to this particular website or personalized content management system.

Your Suggested Articles email. KeepMedia users can choose to receive notifications of content which has been identified as potentially being of interest to them, based on personalization functionality updates which have run on the KeepMedia website.

Week In Review email. KeepMedia users can choose to receive a weekly email which summarizes the top news stories of the past week.

Featured Topic of the week email. A set of articles selected by a KeepMedia editorial team can be offered which provides in-depth coverage on news, events, topics and people in the news.

Your Tracked Articles email. Based on articles that the user has chosen to have “tracked” through the “Track This Article” features described elsewhere herein, users are sent an email when new articles that match their interests become available at KeepMedia.

RSS Feeds. Users can choose to sign up to the KeepMedia RSS feeds and have updates of new content available on KeepMedia automatically made available to them through RSS feeds. RSS feeds can be customized by topic or content source.

Email a friend. Users can email to others specific articles or specific pages that they deem to be interesting. They can also add a personalized note to this email.

(1) Content Management

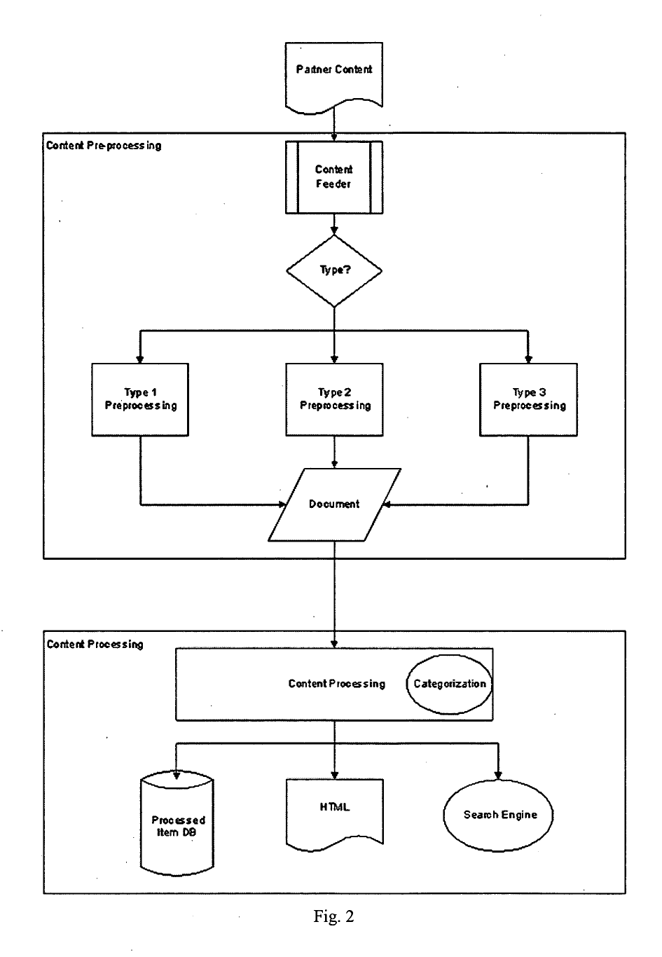

FIG. 2 illustrates the pre-processing and processing steps which provide content management for the methods and systems herein. Content pre-processing may involve the intake of content from the network of partners by a content feeder that is designated for the particular partner. The content feeder sorts or filters the content according to type or format for further pre-processing. No established or uniform format is required for systems and methods described herein so that content may be introduced for example in XML, HTML, PDF or TXT formats. So depending under what type or category the information falls, the content may be sorted by up to three or more types (Type1, Type2, Type3) for pre-processing in order for additional content editing or manipulation that may be required for that particular type of content. Following these pre-processing steps which convert the content into a document existing in a more uniform format, the content may be forwarded in the system for additional content processing. An important component of creating a personalized user experience throughout the personalized websites and provided herein is the timing and scheduling of various content processing. As shown in FIG. 2, these processes include the categorization and grouping of content items for their eventual presentation onto a website or other output for specific individual users. The platforms herein provided in accordance with the invention may schedule certain selected processes to run at certain times. Based on certain user actions, selected processes are performed in order to provide the user with a high level of perceived performance and “freshness” of content. Because it is preferable to avoid or at least minimize delays while presenting personalized results while the user is interacting with the website, the processing is performed with high efficiency as described further herein. Following additional content processing, the information may be stored once completed as processed items in a database that is ready for later distribution. Alternatively, the content may be sent immediately to users in the desired language or format, e.g., HTML, or to members within a distribution partner network that may include search engine companies.

(2) Personalization Functionality

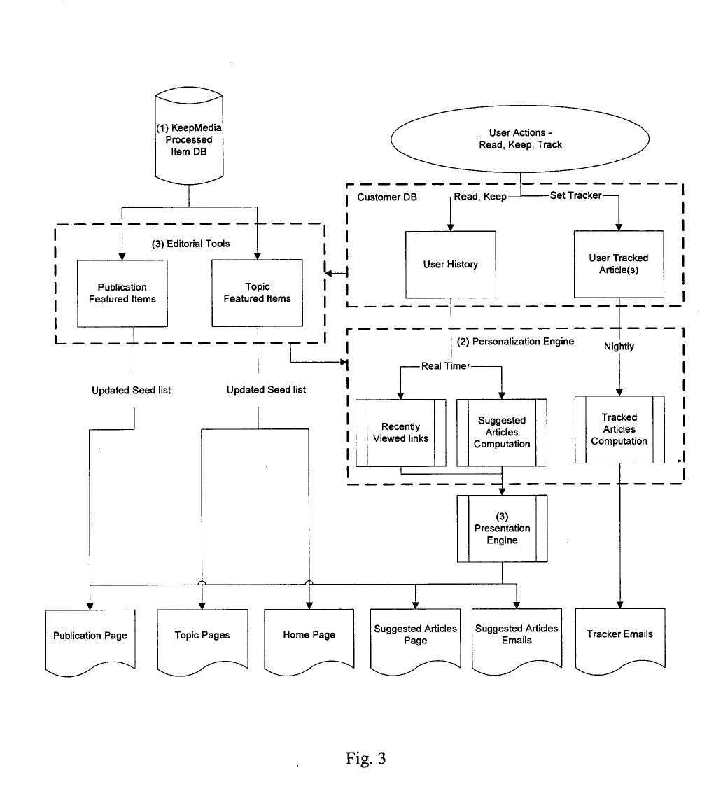

As further illustrated in FIG. 3, the invention provides user personalization functionality that is tailored to specific characteristics and individual tastes. In order to personalize the media content offerings that can be viewed on a website or other media platform, the invention as described herein implements content profiling. A selected collection of items can be grouped together consisting of content that users have searched for, viewed, kept or tracked in the past. This historical information or prior user history can be saved as part of a personal digital content library corresponding to selected individual users. Based upon the selected concepts and topics of interest or content in which users express an interest, an operator of the media platform can recommend other new or highly ranked items which correlate closely with an individual user or defined groups in which users may belong. By implementing concepts of content based filtering whereby for example readers of “Content A will likely find “Content B” of interest also (defined content correspondence A:B), it is possible to avoid using relatively complicated algorithms which rank or score the correspondence between known user interests and material of potential interest. A preselected collection of content and corresponding related information can be contextually filtered and constructed in advance, updated periodically and stored in a database within the content systems herein. Unlike many websites today which implement collaborative filtering and user profiling to personalize their offerings, the invention filters according to content viewed or deemed of interest of a user. Traditional collaborative filtering techniques recommend new items to users because other users with similar histories have read them too. However this frequently requires implementation of a user ratings mechanism. User profiling requires gathering of some personal information about a user, such as age, income, home city, interests and gender, finding similar users with known behavior, and then recommending items these users liked. These relatively complicated approaches can be thus avoided by presenting personalized content in accordance with this aspect of the invention. Accordingly, highly relevant recommendations can be made to users in accordance with the invention that is accomplished in relatively less complicated manner and presented from a media content platform or website.

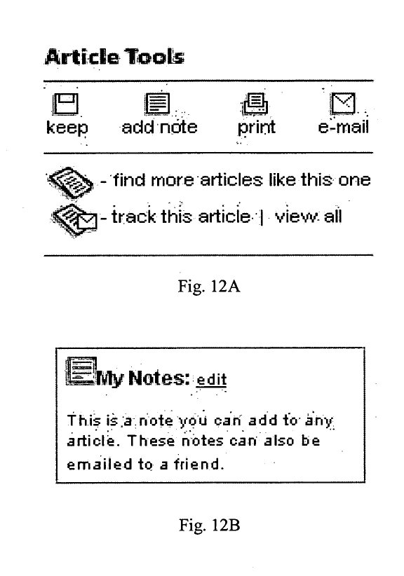

As shown in FIG. 3, the particular actions of a user can be also monitored and stored for future use in customer databases. For example, a set of user actions that may be selected for purposes of the invention often include reading content items, keeping or storing them for future reference, and tracking certain items or reviewed articles for follow-up stories that may be published into the future. These selections or actions may be offered to a user though personalized graphical user interfaces and a series of selected links that are provided in accordance with another aspect of the invention described elsewhere herein. Within a customer database, a media platform operator can maintain records of what users read and keep within a respective personal user history file. At the same time, a tracker may be set so that certain selected items by the user can be tracked for future news or content. The information contained in user history content files may also include content searches that were conducted by a user, particular views of selected content and items, and stored items for specific users. The user history may be accessed in order to suggest additional items of potential interest from a processed item database. Furthermore, a personalization engine may be selected for the content management systems herein that presents selected media items in addition to other suggested items for viewing. In addition to presenting selected items specifically called for or identified by a user by clicking on recently viewed links, the personalization engine may also identify in real-time or substantially near real-time a group of one or more other suggested articles that are linked. This suggested articles computation is preferably performed in a manner that appears effortlessly and seamlessly from the perspective of the user in order to provide a positive user experience on the content website. These results preferably pass predetermined thresholds of relevancy, recency and accessibility—only some users may be given access or rights to view selected content items. This type of functionality for selective presentation of media content can be further expanded and based on the selection and identification of the use of a keyword or group of keywords located in additional items of potential interest. In addition, this functionality offered by the personalization engine is not limited to media content of a single format. For instance, a review of a documentary film may be displayed and come up as a suggestion based on its relevancy to articles a user was viewing through a media platform such as the KeepMedia website. The range of potential suggestions therefore span across the whole spectrum of available media and are not limited to particular categories of formats for movies, books, journals, periodicals and music or online audio content. While tracked articles may be also sought from a processed item database for presentation to a user on a relatively less frequency or nightly for example, the selected and suggested content items however can be presented with more current information that is refreshed more often. The user can activate the “tracking” of any article with a single click. Once activated, an e-mail can be sent to a user with any relatively new articles added to the media platform (e.g., KeepMedia) collection that match the tracked article. The user has the option to stop tracking any of the articles at any time. A graphical user interface may include a tracking button that can toggle between “Tracking Off” and “Tracking On” positions (see FIG. 12A). Additional interface buttons can be included that also allows selection of certain articles or content items for tracking, and for displaying all of the selected tracked items for future reference by activating a “view all” feature with another interface button.

The suggested media content functionality of the personalization engine can be based on a number of established or known algorithms which weigh various factors including, among other things, the current and past actions of a user. These algorithms can be designed with a number of tuning parameters to allow the media platform operator the ability to adapt to changes in the breadth, depth and type content viewed by a user, as well as aggregate user behavior. Moreover, the global parameters for selecting suggested media can be manipulated automatically or manually in order to specifically hone or pinpoint the personalization results with greater accuracy. For instance, the suggested media content algorithms can be adjusted to increase topical relevancy of the results compared to how recently the content was originally published. In addition, this can be expanded to include individual user level controls in order to allow the user (if they should elect to do so) a method of fine tuning their own personalization.

The personalization functionality provided by the content management and presentation systems and methodologies herein can be highly automated. There is an ability to adjust numerous parameters in selected personalization algorithms selected in accordance with this aspect of the invention including, but not limited to the following:
the number of allowed input items selected from a user history
the number of allowed candidate suggested items for a user
the threshold of matching between a user history and candidate suggested items (Note: This threshold can be varied and selected across different words, concepts and/or topics.)
the number of content groups allowed for a user history (Note: Content groups can be groups of content in which the personalization functionality automatically determines are related based on specific parameters and variables such as which words, concepts and/or topics are expressed in each item.)
the depth of content groups allowed for a user history
the minimum and maximum number of items per content group
the particular words, concepts and/or topics to exclude from forming the basis for a group
the frequency with which content groups are automatically reorganized

Additionally, the personalization functionality can be adjusted to account for information associated with a user that is relatively external to the media platform or designed websites herein. For example, information relating to the location or website from where a user arrives can be utilized to offer selected processed content items which may be of interest. When a user links to the website from a business oriented website, the default set of linked topics and articles may be skewed more heavily toward business-oriented topics and sources. These default items may be selected from an already processed content database to be presented and initially populate a personalized user interface areas for the user.

A preferable embodiment of the invention provides methods and apparatus directed to a personalization system that keeps track of user actions such as searching, viewing, keeping and tracking of content. The system may include one or more customer databases that maintain information related to user activities to establish a user history and a tracking record. These databases can retain this information in between user sessions (inter-session) and may be called upon during a subsequent session or visit to a host website. In the event any content items are identified as potentially of interest to a user, they may be presented to a user in real-time during the same session or at a later session. The customer database may be also connected to editorial system that personalizes information presented to a user by supplementation with feature items or other information preselected by a media content provider or retailer. In addition, a personalization engine may present further supplemental content to the user in addition to what is requested for viewing based on one or more contextual algorithms. The supplemental content may be identified and result from computational processing for suggested or tracked articles that is based on customer database information. These contextual algorithms may define relatedness of content items that go beyond the mere presence of identical keywords or features found in a content item. Accordingly, personalization methods and apparatus herein can automatically suggest a refreshed set of items that provide related content of interest each time a user visits a website.

While significant functionality is offered automatically to drive both selected and related content of interest to a user, the invention herein also provides users with their own ability to override or control the manner and type of presented content. A key design element to the personalization functionality of these media platforms is that the process can be driven primarily by the actual interactions themselves between the user and the viewed content described above. As a result, the user is not required to answer specific questions about their preferences, for instance, in order to obtain personalized results. Selected content can be driven to users without the need for extensive initialization or user profiling which may be time consuming and complicated. Nevertheless a user is given the ability to override certain elements of the personalization functionality, if the user so chooses. The following are examples of user-directed control functionality provided in accordance with this aspect of the invention:

Exclude Content Function. Users can choose to exclude a specific content source, like a publication, from all future personalized results presented to them by the media platform. For example, users can exclude from any presentation to them of any content items from the National Enquirer tabloid. This can affect all elements of the website which are driven by personalization, and not just certain portions of the site. Of course a user can also decide to later view and re-instate the sources that were previously chosen to exclude. The advantages provided by the invention recognize that user interests change over time so the ability is provided to be adaptable and personalized into the future.

Favorite Sources Function. The personalization functionality of the media platforms herein can also automatically and progressively rank sources of content for each user based on past actions of the user on the website. This feature can be expanded to allow the user to partially or fully override these automatic rankings and manually set their favorite sources. So regardless of ranking may result based on user actions, it can be assured that the most desirable or favorite content can be provided from various or selected content sources.

Find More Like This. The user can manually prompt the personalization functionality to create a list of content that is related to the content being currently viewed. When selected content is being viewed by a user, additional articles or content can be requested that is somehow related or similar to currently viewed content by clicking on a “More Like This” button within a graphical user interface. This type of button can be positioned within a user interface adjacent to the content being viewed in most page formats.

Advanced Search. The personalization functionality can be expanded to allow additional dimensions of user control. For instance, the user could be allowed to control the date range, publication or topic of the content returned by the personalization functionality. In fact, any of the control elements described herein can be exposed to and controlled by the user. Depending on the desired level of control and user level of skill with respect to tailoring computer user interfaces, this level of controlled presentation and functionality can be expanded to incorporate user searches for content based on Boolean logic and many other selected control elements supported by the interface.

As described in greater detail above, the personalization process and presentation of various media content can take place through a website, e.g., http://www.KeepMedia.com, in accordance with this aspect of the invention. Because these processes are often performed in real-time while a user is visiting the website, the functionality offered should be thus relatively fast and effective. The architecture of the platform and content management process provided herein efficiently places content, images and other item data as close as possible to a page rendering or presentation engine in order to maximize performance and redundancy of the environment. In addition, the timeliness of the processes by which content is received, processed and loaded onto the system is an important element of making the overall system and user experience efficient and effective. The selected and suggested content items can pass through the presentation engine for customized viewing by a user (see FIG. 3). So in addition to presenting suggested articles pages and emails to a user, the presentation engine can also display other forms of content selected by a media platform provider. For example, other items already processed and stored in an item database may be selectively edited and promoted. A series of editorial tools may also combine and modify this content as with other selected content such as publication and topic featured items. In this manner the media platform provider can exercise some level of control in presenting targeted content and information to selected users. These non-user selected content items can be maintained on one or more seed lists to be presented at desired time intervals to new users as well as prior users, and at different locations on a website. For example, publication featured items such as those running in Newsweek can be specifically displayed on a designated Newsweek publication page. When content items are identified and fall under selected topics or categories, they can be also kept on their respective seed list for subsequent presentation on selected topic pages or home pages for selected new or all users. Accordingly, the presentation engine processes the user selected and non-user selected content that is to be presented in a highly customized and carefully designed presentation format to the user to achieve a desired online experience and effect.

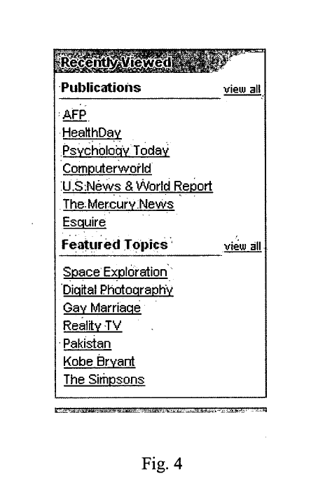

Another feature of the personalization functionality offered herein can be also applied to new or first time users. Since the user experience on the media platforms provided herein such as the KeepMedia website is highly personalized, the process can be preferably seeded for a new user. This is done through pre-setting certain parameters for the new user so that interesting content can be presented to them from their initial visit to the KeepMedia website. Once the user begins interacting (viewing, saving, printing, etc.) with content on the KeepMedia website, the personalization functionality replaces these seeded parameters with parameters based on the users actions. For example, as illustrated in FIG. 4, a personalized element or “Recently Viewed” list can be presented on the Home Page of new or even prior users. A preselected number or list of up to seven or more “Publications” can be featured, and at the same time a preselected number or list of up to seven or more “Featured Topics” can be offered. Links to any or even all of these content items may be viewed by new users or derived from the prior reading history of prior users which allow for quick and convenient return to pages they may have recently viewed. These lists of Publications and Featured Topics can be updated in real time which can again be tailored according to user selected parameters or content items being viewed by a user during current or prior sessions online.

(3) Content Presentation and Interaction

Once the media platform identifies content that may be of interest to a user, content can be presented in a manner that makes the user experience easy, intuitive and fin. This can be accomplished through a number of distinctive content presentation elements on the media platform provided herein.

Homepage

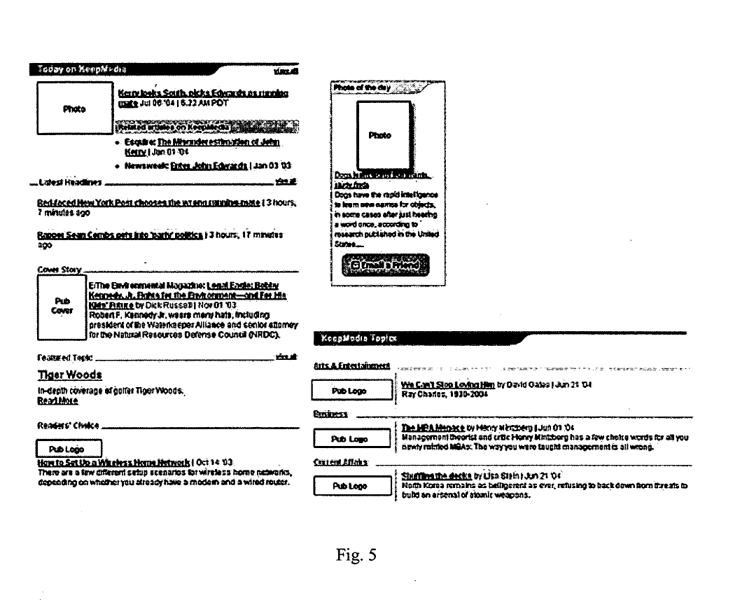

As shown in FIG. 5, a homepage may be designed for a website which presents a number of media content summaries and initial information. These selected homepage content summaries can showcase some of the content available on the website, from a variety of sources and covering various topic areas. Moreover, content summaries can be designed to provide users with an update on breaking news, review prior related articles or archived content, get a broader perspective on the main news stories, dig deeply into an issue, browse the full breadth of topics and publications available or share an interesting photo or story with friends. The content highlighted in these summaries can be controlled by the media platform provider using editorial tools described elsewhere herein, and can also include content automatically personalized to the individual user based on their prior activity on the website. Only a subgroup of immediately viewable content items may be presented within the homepage summary, or a full or more complete listing of content items can be offered (view all).

Today on KeepMedia. For example, on the homepage of the KeepMedia website, users are presented with several distinct content summaries including items under the heading “Today on KeepMedia.” Top current news stories can be each presented with relevant related archived articles. This allows KeepMedia and other media platforms provided in accordance with the invention to significantly enhance the user's experience, and demonstrate the power of the KeepMedia Platform, by linking current content with the deeper content archives.

Latest Headlines. Selected media content from newswires and other high frequency sources can be updated many times per day as desired (e.g., hourly) so that users have quick and easy access to a selection of very recent news stories. These headlines can span a wide range of topics offering late breaking news such as those presented on CNN.com.

Cover Story. A selected cover story may be also presented on the homepage or any other section of the website. This can be updated as often as desired such as hourly, daily or even weekly. Depending on editorial decisions and judgment, certain editorially selected cover stories can be presented from specific issues of publications which are also available on websites such as the KeepMedia website. So in addition to presenting cover stories or content that is deemed to be of interest, further opportunities are created to present the user with other related content items by subject matter or publication, e.g., Psychology Today, in the event the cover story item is selected for viewing.

Featured Topic. The user can browse multiple, separate collections of articles built around popular search terms and timely news issues such as global warming, Election 2004, gay marriage, reality TV, cloning, and obesity. These pages can be designed to highlight the breadth and depth of the content within media platforms provided herein, providing subscribers with a convenient way to stay current with a particular topic, while also allowing them to dig deeper into archived content. A user is thus given the chance to read a complete article or more related articles after selecting a “Read More” link to the content item when a blurb is deemed to be of sufficient interest by selecting a displayed option.

Reader's Choice. A selected literary piece or content item can be emphasized also based on user popularity. A “Reader's Choice” item can highlight one or more popular content items based on various measures of popularity, such as the number of times the items has been (i) viewed by other users or (ii) sent through our email or tracker function described elsewhere herein. This allows interesting stories that are highly viral in nature to be exposed to other users of the media platform or website.

Photo of the Day. An editorially selected photo and related story as a “Photo of the day” can be presented to users. As with other displayed content items that can be presented within the user interfaces herein, a convenient “Email a friend” button can be also provided to encourage the sharing of the photo that can be accompanied with a blurb to a corresponding story. A full version of the story can be of course viewed upon selection of a link thereto, which allows yet another opportunity to present related content that may be of interest to the user based on the selection of the accompanying story.

KeepMedia Topics. A user can also browse through topically focused content from a number of publications in one place. For each selected topic or category of content, e.g., Arts & Entertainment, Business, Current Affairs, a particular publication can be offered for further viewing. The publication can be represented by a sample issue front cover, or by its logo or trademark. For each topic and featured publication, a recent sample article from each corresponding publication can be presented. Basic byline information can be also provided for the article or content, and a link can again provide a user with a chance to review a complete version of the piece being promoted for that particular publication. The user can also decide to browse all the content or issues from a particular publication or magazine by clicking on the publication logo, e.g., all Esquire, BusinessWeek, Reason.

The Rack

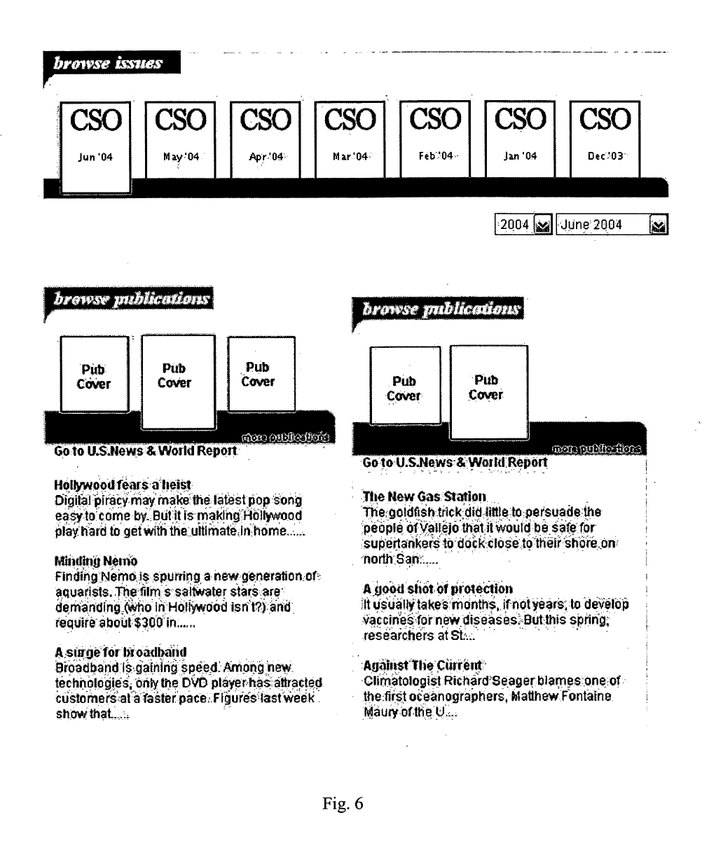

As shown in FIG. 6, another aspect of the invention provides graphical magazine “rack” representations which uses a natural browsing metaphor to present users with multiple content items. The Rack provides an intuitive layout for magazines and other publications to be displayed as if the user was “browsing” or looking at them on display at a retail store or library. The systems herein can automatically populate sections of the graphical user interface dedicated to the Rack based on where the user is in the system, and what items are searched by the user. In some instances, the contents of the Rack may reflect what the user searched for, viewed and/or stored in the past. The Rack can be customized for different areas of the website or media platform depending on the desired focus and effect by the media platform provider or user. For example:

Publication Home and Issue Page. As shown in FIG. 6, the Rack supports traditional sequential issue based browsing. Within a “browse issues” section of the interfaces herein, the Rack may present thumbnails of front covers to magazines or other publications in chronological order. The displayed issues may range from currently available newsstand editions to those going back several months. For example, a June 2004 issue of a CSO magazine can appear on the left hand side of the Rack as many English speaking countries read from left-to-right. A currently selected issue may also appear more pronounced on the Rack by superimposing the image of the issue in front of it so the full cover can be viewed by a user. By clicking on this issue presented at the forefront of the Rack, its contents may be further presented to the user. Other issues of the selected publication can be made available on the Rack by clicking on those corresponding front page images. The published issues for the last several months or other predetermined time period can be modified by a date selector box in the user interface. A series of pull-down or drop-down windows (year/month year/date month year) can be provided to present archived issues from different time periods on the Rack.

Topic Page. The Rack can also show topically related publications drawn from all publications available on the media platform or website. For example, an embodiment of the Rack can include thumbnails of front page covers within a “browse publications” section of the interface relating to Entertainment or Science related publications and news. Other preselected categories of publications can be presented also such as Technology, Humanities, etc. A selected publication cover can again be clicked-on by a user or passed over with a mouse cursor to bring the content item to the forefront of the Rack. The contents to that issue or particular content item can be also displayed when selected. While only portions of the Rack can be displayed at a selected time if desired, more publications can be viewed on the Rack or alternatively a larger Rack representation can be presented displaying more publication covers to a user.

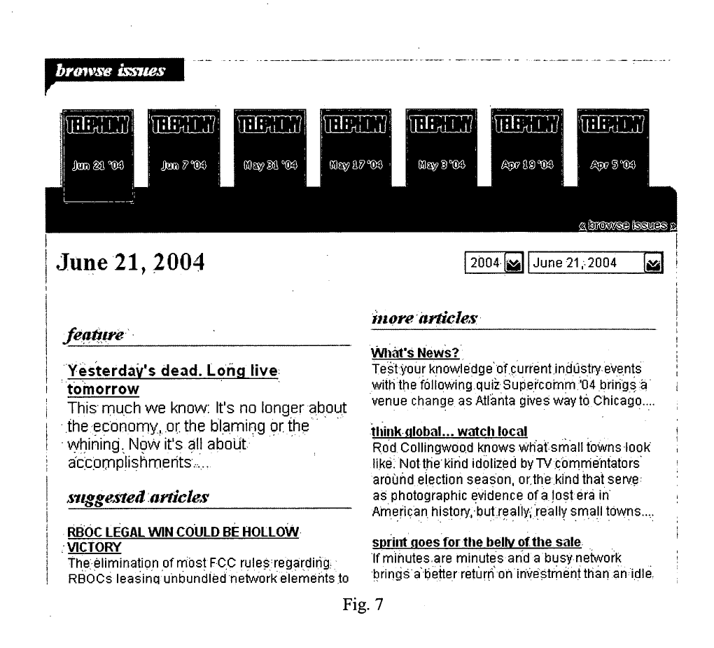

The racks provided herein in accordance with this aspect of the invention can be used in many different ways and in many different places on a media platform or website. As illustrated in FIG. 7, a Rack can be used to display content from a single source or publication such as Telephony. This is an illustrative example of how the Rack can be used to automatically display different or date specific issues of the same publication, and/or display issues for varying ranges of time periods. Moreover, from a selected issue that is presented at the forefront of the Rack, different content from the same issue can be viewed depending on where the Rack appears on a website. The user can choose to see content from any magazine or publication issue displayed on the Rack. In the example provided, the user has clicked on the Jun. 21, 2004 issue of Telephony. The relevant issue is distinctly displayed by placing the relevant graphical element completely in front of the rest of the graphics in the Rack. The selected content from that issue can be displayed immediately below the Rack and date of the selected issue. In order to view content from another issue displayed on the Rack, the user would click on the graphic representing that issue (in this example, the issue cover picture). Furthermore, to see more issues than are currently displayed on the Rack, the user can click on the directional elements of the browse toolbar which is displayed within the rack. In the example below, the browse toolbar appears in the lower right corner of the rack as “<<browse issues>>.” According to certain editorial choices, featured items or suggested articles can be also presented from the selected issue too. Additional or more articles can be linked and displayed for further viewing which cover a different range of potential interest to the user. The illustrated examples show different displays based on different personalized topics but it can be expanded to display content for other content attributes.

Navigation Bar

Another component of the graphical user interfaces provided herein includes a variety of navigation bars. A navigation bar may be considered an integral component of the personalization functionality of a media platform because it can provide the user with a consistently placed control point for interacting with the media platform. A primary purpose of the navigation bar is to enable the user to navigate around a website and interact with content. This controller can appear on every page within the website, and can be excluded however from pop-up windows. For certain applications, selected portions of the navigation bar may change based on what area of the website the user is currently viewing, and the type of content the user is viewing. Another portion of the navigation bar can remain consistent throughout the website.

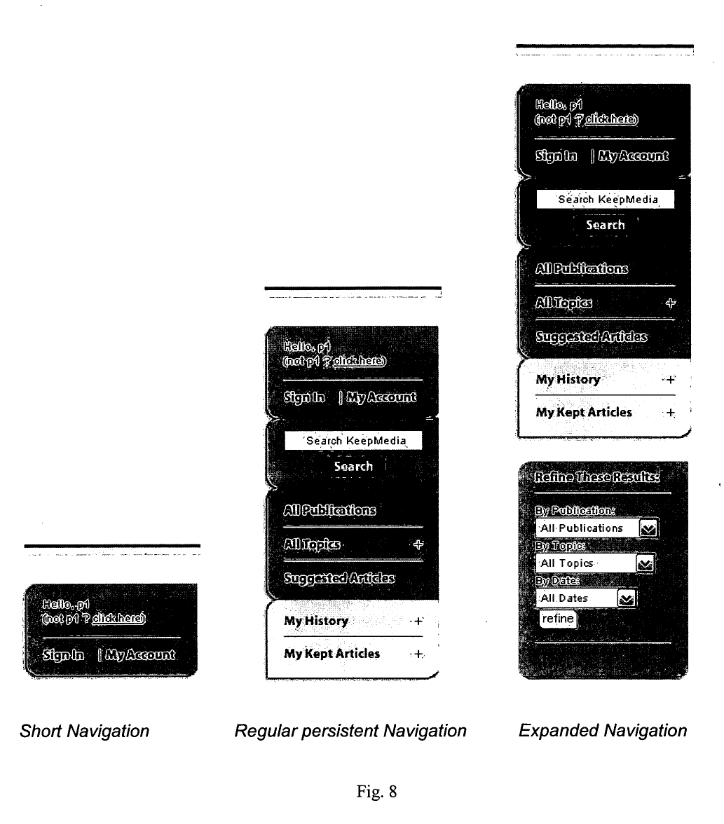

For example, as shown in FIG. 8, a set of optional navigation bars is provided depending upon the desired type of navigation: Short Navigation, Regular persistent Navigation, and Expanded Navigation. The Short Navigation bar provides basic options to a user such as sign-in and out features, and also a button to access account information (My Account). The Regular persistent Navigation bar can provide the same basic options, but can also include a website box for keyword searching. A user can also navigate to specific portions of the website to view a listing of all publications that can be viewed or a listing of possible topics under which content can be organized. The user may further choose to directly review content limited only to suggested articles which have been automatically identified in accordance with the invention. In order to backtrack or easily identify what content has been viewed and kept previously, a set of user history (My History) and kept content listing (My Kept Articles) buttons can be provided within the navigation bar. The Expanded Navigation bar can include all of the functionality described for the other bars in addition to further refinement options. The bar can include a portion dedicated to further narrowing or refining of content that is searched and displayed. For more focused searching, a user can limit searched results differently as desired, e.g., by publication, by topic, by date. Upon a selection of default parameters by the user, a refine button may be activated to initiate refinement of the results.

The following are illustrative examples of how these and other navigation bar provided in accordance with the user interfaces provided herein can appear on selected platforms such as the KeepMedia website:

Presentation Pages. The KeepMedia Platform can be designed to give the user a consistent look-and-feel throughout many personalized levels within the KeepMedia website. Primary presentation pages include:

Publication/Publisher Page. Presentation page format used for all content by a source regardless of attribute, such as date published, topic or author.

Issue Page. Presentation page format used for content published in a particular issue or within a specific publication date timeframe.

Topic Page. Presentation page format used for content related to a particular topic regardless of source.

Featured Topic Page. Presentation page format used for editorially selected content related to an in-depth view of a particular featured topic regardless of source.

Article Detail Page. Presentation page format used to present a single item of content.

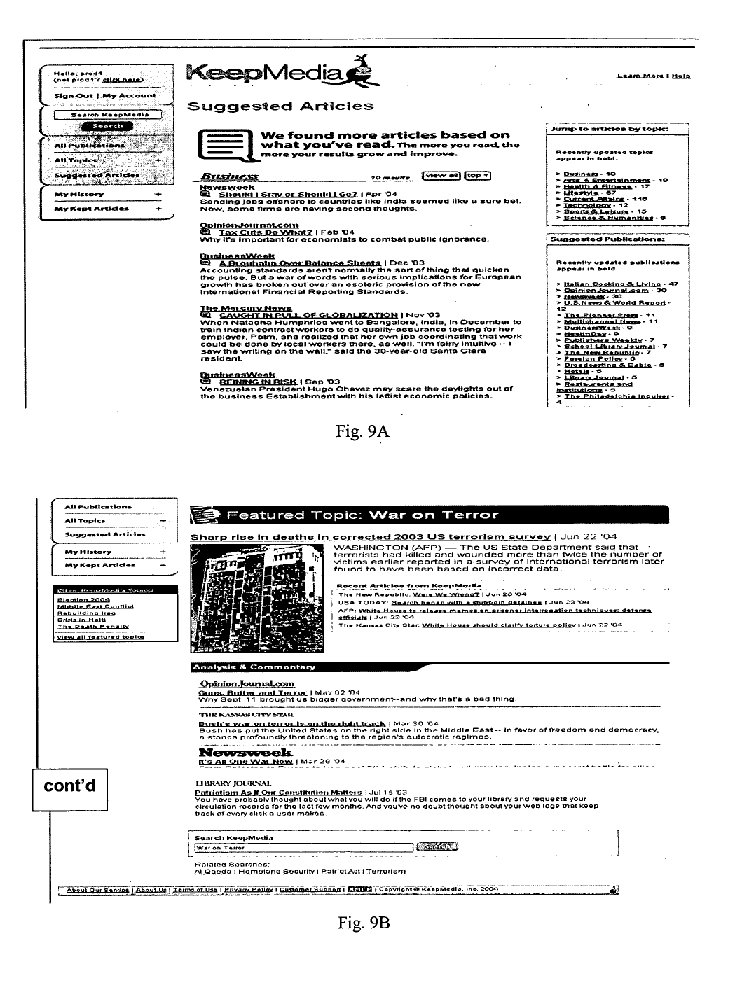

FIG. 9A illustrates a Suggested Articles Page that presents selected content in accordance with the invention. A personalized selection of content from across all sources available to the user on KeepMedia website can be presented through this Suggested Articles page. This provides the user with relevant and fresh content is presented on a regular basis. Throughout the displays for content on a website, a Suggested Articles link or button can be included on the interface which leads to this page. The page can thus offer relevant content and articles that can be based upon user preferences or otherwise logically tied to what has been read by a user up until that point in time.

FIG. 9B illustrates a Featured Topic Page for presenting specially selected content in accordance with another aspect of the invention. This page can provide a grouping of content around a particular topic. These pages can be created by employees or editors of the media platform provider. The selection of content for this grouping can be based a variety of editorial variables such as user popularity and relevant current issues that are “hot topics.” The editors create these pages using special tools or editorial tools available within the content systems herein. It should be noted that any content related to items within these topic pages can be tagged or otherwise identified so that a special banner or indicator can be displayed when a user views that content item through a search results or article detail page. Accordingly, a user an readily identify what content are characterized as feature topic items when reviewing search results, clicking on a corresponding link or button to review details about an article of content, or navigating through other portions of the website.

Presentation Elements

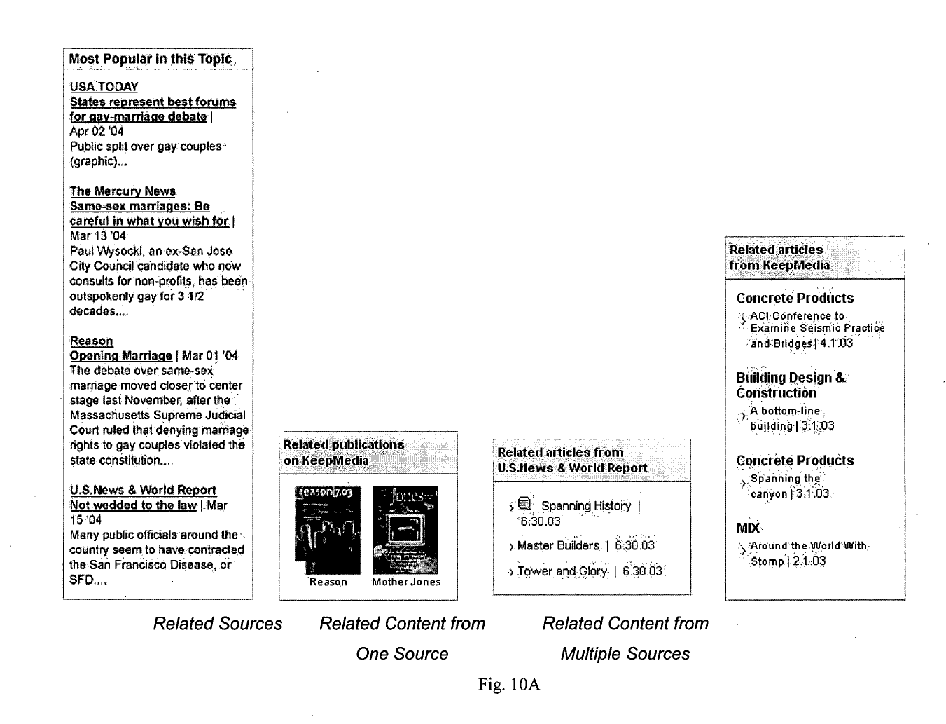

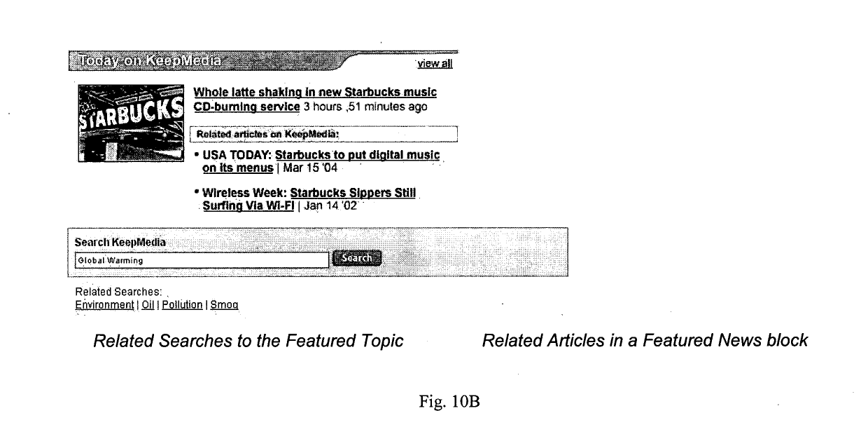

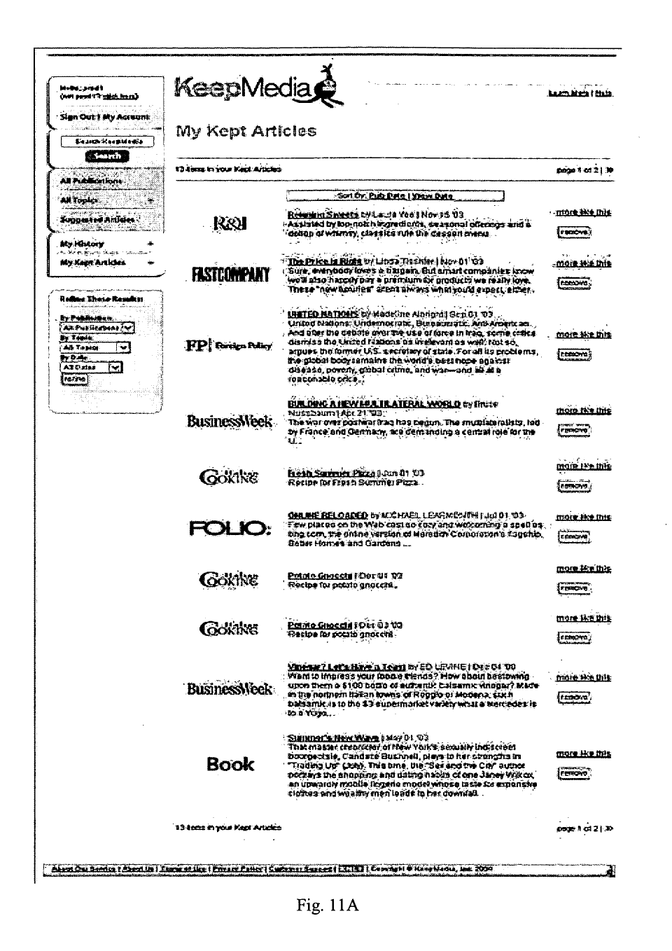

Within any presentation page on the KeepMedia website, personalized content can be displayed to the user in a variety of ways. The illustrative examples provided herein depict how personalized and “related” content can be presented to the user. For example, as shown in FIG. 10A, a preselected group of related stories about a particular topic, e.g., same-sex marriages, can be displayed in a portion of the user interface (Most Popular in This Topic). Based on upon the number of times a piece of content is selected for viewing or otherwise presented to a user, a list can be compiled identifying in order the most popular content items within a defined topic from various magazines, newspapers, journals and any other type of media. Accordingly, the personalization functionality of the content management and presentation systems herein can automatically create lists of sources, topics and individual items that may interest a specific user based on what other users are have viewed. Furthermore, a grouping of publications or magazines can be offered in a selected window of the user interface (Related Publications on KeepMedia) in the event the user decides to view a content item from one of the publications within the related group of publications. For example, presentation of a family-related content item may prompt a related publications box to be displayed promoting other available publications on the media platform such as Family Circle or The Knot. A thumbnail illustration of a current front page cover may be provided within the box for the publication which may be clicked-on and selected. As with other individual features of the invention herein, the selection of a particular publication within a user interface may direct the user to a publications page primarily dedicated to that magazine or content provider selected so that a number of current and archived issues can be neatly displayed on racks described elsewhere herein to simulate a more realistic browsing experience as if the user was thumbing through stacks of magazines, newspapers or other publications.

FIG. 10A further illustrates related articles boxes that can be displayed on the media content user interfaces provided herein. For example, a number of blurbs and byline information corresponding to related content can be selected and displayed from a single publication, e.g., U.S. News & World Report, or related content can be presented from multiple sources within the related articles box. Again the user selection of an item from any of these boxes can initiate the presentation of other content that may be deemed of interest to the user based on topic, type of publication, predefined user parameters or user profile and history information.

FIG. 10B illustrates again a number of related articles within a Featured News block covering a particular topic from various sources, e.g., presidential election, that can be editorially designated as popular information and displayed prominently (Today in KeepMedia). In yet another example of how related content items can be presented to a user, FIG. 10B illustrates a search box that presents related search topics in response to the a featured topic or keyword string entered by the user to be searched. This promotes the viewing of available content within the media platform based upon a logical connection and relatedness between actually viewed contents and those to be presented or suggested to a user.

Personal Digital Content Library

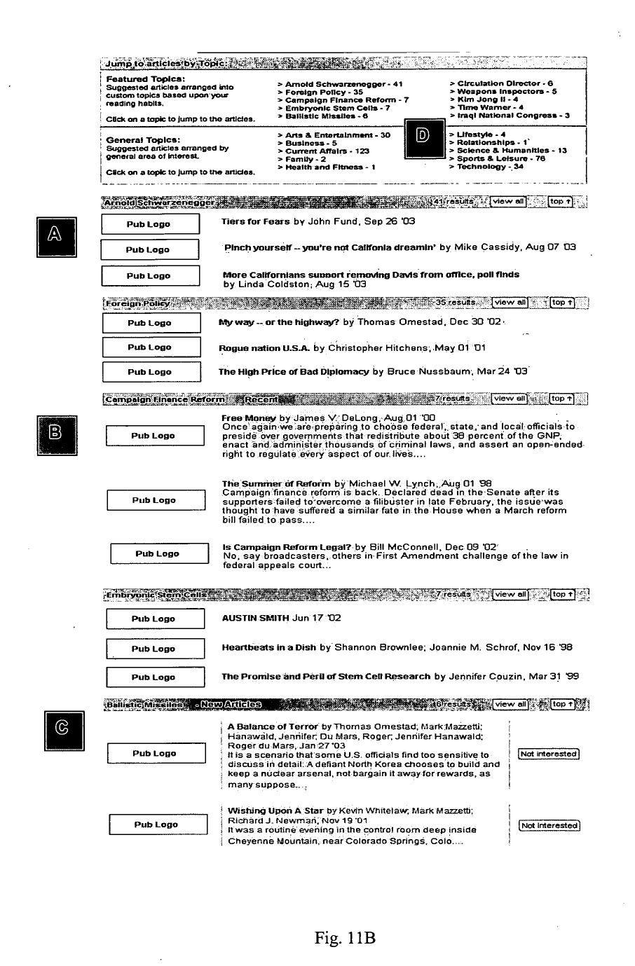

By registering with a provider of the media platforms provided herein, each user can be provided access to their own personal digital content library. The websites or platforms hosted by companies such as KeepMedia can save user-selected content as well as any notes added by the user to the content. For example, as shown in FIG. 11A, a user can navigate through a website to a designated page that provides access to the personal digital content library. The page may display variations of a navigation bar described elsewhere herein that also includes a button selection leading to the page, “My Kept Articles.” The Kept Articles or contents of the personal library can be displayed in a variety of formats and sorted in various ways (<<Sort by Pub Date|View Date>>). Pages of the content can be displayed one at a time turned consecutively (<<page 1 of 2>>) or the interface may include a link to each page thus allowing the user to skip directly to a page (<<pages 1|2|3|4|5|. . . . >>). An additional refinement tool box may be added the interface as well which allows the user to refine and sort contents of the personal library according to selected parameters such as by publication, topic or date. The contents previously selected and kept in the library by a user can be displayed with a graphical logo or trademark identifying the publication or media content source, title and byline information, and publication date. A blurb or few sentences from the content item can be also displayed with a link to a page showing the full story or complete article (Article Detail Page). The user can also decide to delete certain contents from the library or add more content that is like or similar to the stored content by selecting among a series of links and graphical buttons such as “remove” or “more like this.” Accordingly, a user can access their own personal library from any Internet-connected computer by simply accessing a host website such as KeepMedia, and then logging into their KeepMedia account. Some additional functionality and features of these and other personal digital libraries provided in accordance with this aspect of the invention include:
allowing the user to search for related content items based on items previously saved
allowing the user to “filter” through different views of their saved items: by date, by publication and by topic
automatically organizing content items within the library based on a variety of parameters including topic, publication, date saved and date viewed
allowing the user to adjust various parameters in the personalization algorithms related to their personal library, including: (i) words, concepts and/or topics to exclude from forming the basis for a group; and (ii) the frequency with which content groups are automatically reorganized

A preferable embodiment of the invention provides methods and apparatus for keeping selected items within a personal digital content library. The content library may be accessed through a graphical user interface listing each of the kept content items. The listing may be sorted chronologically (forward and/or reverse), by topic or any other field including those mentioned herein. Upon selection of a content item by one or more associated links, the stored content item can be viewed. The associated links may include the logo or graphical representation of the publication from which the content item originated, or any other highlighted portion of the byline displayed. In another variation of the invention, the content library interface may include a link asking for more content related to an item listed. By clicking-on a “more like this” link, additional suggested articles or other content items can be identified and presented within the interface for viewing. This personalization functionality can be combined with other aspects of the invention including personalization and presentation methods and systems provided herein.

FIG. 11B illustrates another embodiment of the invention that provides a personalized content library automatically organized for users or arranged according to personal preferences. This provides each user with personalized page/space for saving, viewing and/or organizing their media. As with other variations of the invention described herein, the media content may be derived from publications including newspaper and magazine articles. But other types of digital media may be stored in personalized libraries including video, audio and items from other available medium. The selected content items can be thus stored and conveniently located at a single location dedicated to the particular user.

Additionally, these content libraries may include an automatic organizing and categorization feature. This feature can group different articles and content items into convenient and logically named groups/topic headers based on the actual content contained within an article. The structure and contents of these groups may be retained between user sessions or inter-session regardless of the particular date the item was kept or viewed. At the same time, each article or content item may be designated or belong to more than one group. For example, articles about Arnold Schwarzenegger can be grouped under a topic header “Arnold Schwarzenegger” (Area A) as illustrated. Some of the same content items however could also be listed under a different category such as “Summer blockbuster movies” or California politics. Various portions of the graphical display to the content library may be broke up as shown with category borders or folder tabs listing a particular topic, the number of corresponding results (41 results) contained therein. A selected number of content items may be viewed along with a graphical logo corresponding to the originating publication or media source (e.g., most recent three) while suppressing other results within a certain category, or all results can be viewed. Each displayed item may include basic byline information and a link to the full content of the article or item for viewing.

Any customer can be given the option of either allowing a provider such as KeepMedia to automatically organize the selected articles by a user according to predefined categories or topics, or each may decide to explicitly create their own item headers or point headings (Foreign Policy, Campaign Finance Reform, Embryonic Stem Cells). The contents may also be automatically categorized and included within designated groups, or a user can alternatively decide what articles belong within each group. Furthermore, a customer may be elect to have their library scheduled to be organized as needed or at a specific frequency e.g., weekly. A combination of the two methods will also be supported wherein certain categories are updated at different times. A group of recently organized topic areas can have some status indicator (Area B).

This personalized content area can also be used display new personalized articles or media found for a customer matching their prior viewing and user interaction history described elsewhere herein (Area C). Depending in part on what a user viewed previously on the media platform, additional personalized articles may be presented to the user for viewing that are related or falling within the context of what was considered of interest before (Ballistic Missiles—New Articles). Should the user decide that the newly presented content is not relevant or of interest, the user interface may include a “Not Interested” button that may be clicked-on to remove the selected item from the content library.

Another feature of the personalized content libraries herein includes an index to all of the topics and content kept in a particular user library. A series of previously kept or organized articles, topics, can be linked to quickly from the link shortcuts at the top of the page (Area D) or any other designated area of the user interface. As a result, users can jump to a particular article or content item after clicking-on its corresponding topic link. For example, the user interface may separate the topics into two sections: Featured Topics and General Topics. The Featured Topics may include suggested articles of interest to the user based on prior viewing patterns and user history. This defined grouping of Featured Topics may again include total item counts and subsequent links to items that were explicitly selected or kept by the user, in addition to personalized topics that could be of interest based on the reading habits of the user stored in customer database. The General Topics may include a predefined listing of general news and interest and other categories commonly used by media publication companies. By clicking-on the link to any of these general topics, the user can access the kept or selected content items within each category which have been already sorted according to those topics listed. Total item counts may be similarly provided next to each topic to indicate how many content items or articles are kept in each topic.

The preceding are illustrative examples of how a user would view the items in their personal digital content library from the KeepMedia platform. It shall be understood however that the invention described throughout herein also provides other types of media platforms and is not limited only to these particular websites or personalized content management and library systems.

Content Interaction Functionality

The KeepMedia Platform allows the user to interact with content in a number of different ways. The content interaction functionality is available to the user through a toolbar that appears adjacent to the display of content items on the KeepMedia website. For example, graphical user interfaces provided herein can include a tools box for a user (Article Tools) as shown in FIG. 12A. This tools box may include selected functionality that are desired typically by users including keeping or saving viewed content tot he personalized library, adding personal notes or comments corresponding to content, printing the item to a connected printer device and emailing the selected content item(s) to the user, friends and others. A series of suitable icons or other intuitive pictorial representations may be included as or adjacent to a button on the user interface corresponding to each function:

Keep. The user can save a content item, including any corresponding note(s) they previously added, into their personal digital content library.

Add Note. This function allows the user to make notes and attach them to a specific item of content. The user can view, edit and save these notes. When the user interacts with an item of content to which they have added a note, they can choose to include the note in the action. For instance, when they view, print or email an item of content, they can choose to include their note in the view window, the printout or the email message. FIG. 12B provides a screen shot from the user interface as an example of how a note could be displayed with an article on an Article Detail Page. The note box (My Notes) can display text and include an edit option or button to allow further editing.

Print. The user can print a content item. This function can be expanded to allow the user to choose whether or not to include in the printout any note they have previously added to the content item.

Email. The user can email to others specific articles or specific pages that they deem to be interesting. These emails can contain an introduction from the user, a preview of the content item and a unique hyperlink which allows the recipient to view the full content item on the KeepMedia website. The user can also choose to include or exclude any note(s) previously added to the content item. Restrictions can be set such there is a maximum number of email addresses to which the user can send these emails.

As with other displayed pages in the content management systems provided herein, the Articles Tools may include offer options of tracking or finding/viewing more articles and content pieces similar to a particular item.

Find More Articles Like This One. The user can manually prompt the personalization functionality to create a list of content that is related to the content they are currently viewing by clicking on the “More Like This” button which is adjacent to the content in most page formats provided herein.

Track This Article. The article tracker enables readers to follow recent coverage of specific subjects, people, places or companies through customized e-mail alerts. When new articles that match their interests become available at KeepMedia, readers are notified as desired such as once daily or as often as new articles become available. Each user can furthermore track an unlimited number of articles, and alerts can be turned on/off at any time.

Search Results

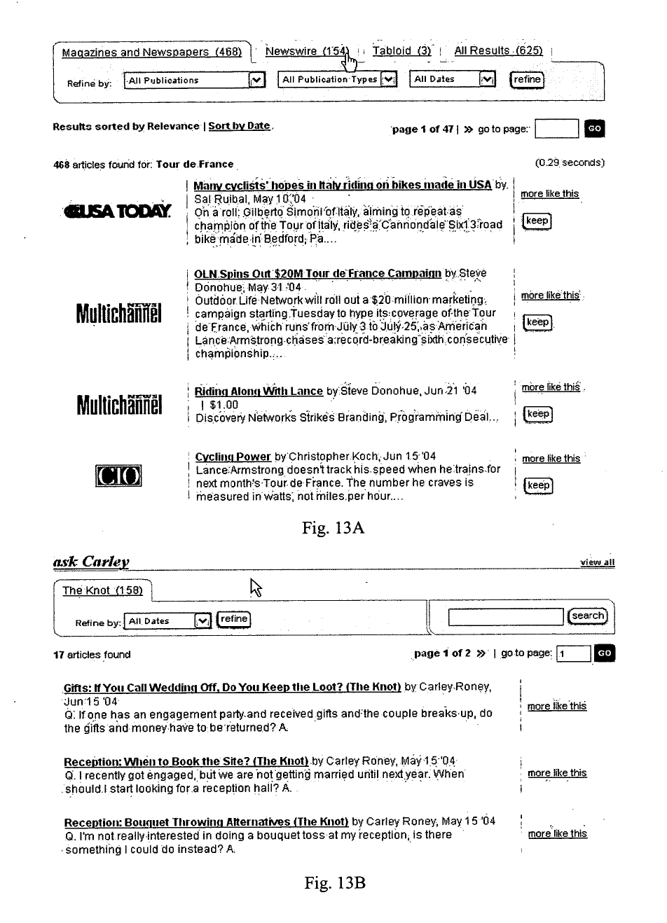

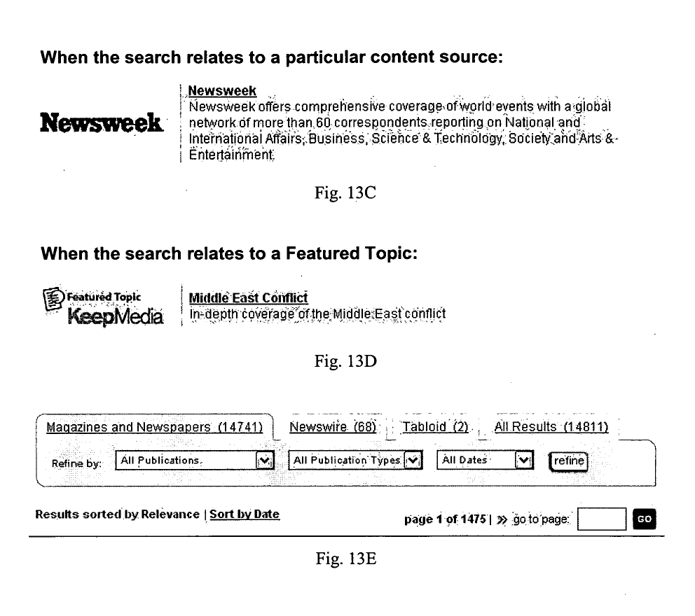

When users execute search queries on the KeepMedia website, the KeepMedia Platform presents the results to the user in different ways depending on the type of results that are generated. For example, FIG. 13A illustrates search results provided when the user searches within a recurring feature (a pre-refined search), e.g., Tour de France. The searched content items can be displayed in a manner similar to the My Kept Articles page, including a total number of items identified and related searching/processing for the search. The results of the search may be also sorted by relevance or sorted by date. The pages of results can be presented one page at a time and viewed consecutively (<< >>) or a user can jump or go to a specific page by filling-in a page number box (go to page) as illustrated for this embodiment of the invention. A refinement bar may further be displayed along with a numerical breakdown showing the total number of publications contained within the content system and the types of publications to which they belong (FIG. 13E).

FIG. 13B provides a display when the search relates to individual content items. A selected navigation bar and listing of contents with title and byline information can be provided, including link or button to an Article Detail Page for full viewing of a piece. FIG. 13C illustrates a display when the search can be done within a particular content source such as Newsweek. A brief description about the source can be also provided. FIG. 13D provides a display of a search result displaying a featured topic. A suitable graphical representation can be selected to accompany the identified topic along with a blurb or short description relating to the topic. As shown in FIG. 13E, the presentation of the search results also includes a header which allows the user to refine the search by source, publication type and/or date. The results can also be sorted by relevance and date, and further listed on multiple pages with page skipping functionality. The types of publications can be further displayed to a user and respective number of sources within each one. A header bar or modified refinement bar can include a link or button leading to the respective groups of publication types (magazines and newspapers|newswire|tabloid|all results) which are identified by type of publication and a corresponding total number of sources within each category (Magazines and Newspapers (14741)|Newswire (68)|Tabloid (2)|All Results (14811)). A preferable embodiment of the invention directed to this aspect of the invention provides a user interface that displays a header bar with a plurality of media tab folders. The media tab folders may correspond to a preselected group of publication types, wherein each folder includes a tab that displays the type of publication and the number of content items falling under that particular type. The media tab folders include one or more links that a user may select to view contents within each content folder. Another embodiment of the invention includes a refinement bar that includes a series of pull-down menus that allows a user to sort and view all of the content items within the media folders, or alternatively, according to publication type and/or dates.

Editorial Tools and Publishing System

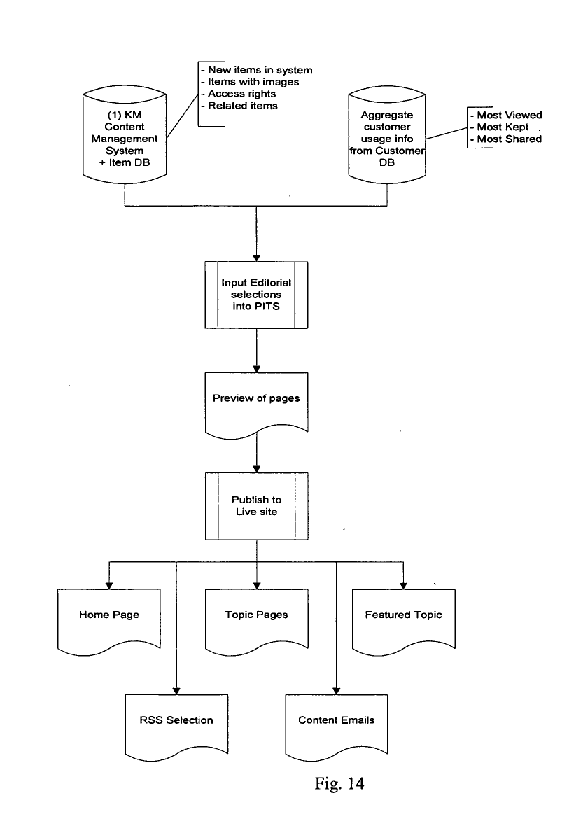

The personalized content management and presentation systems provided in accordance with the invention can include editorial tools and publishing systems which allow relatively non-technical employees to quickly and easily manage certain aspects of a content website or media platform. As shown in FIG. 14, an editorial system can be in communication with and receive both available content and customer specific information from a series of one or more databases. The content management systems described herein can access processed content items for presentation. These content items may include newly processed information and articles, already stored or archived content which may include accompanying images along with text, and items that may be deemed relevant or of interest to a user. At the same time, the editorial system can draw on specific user information from a customer database that includes historical data and aggregate customer usage. This data can be monitored so a host can identify which content items are most popular, and what content could be deemed relevant and/or related for selected users. For example, the customer database could include those items which are most viewed, most kept, most shared, etc. The editorial tools and publishing systems herein process information from the customer and content management system and databases so that content can be easily presented with editorial selections and modifications as desired by a website host or media platform provider. Upon making editorial changes, the selected pages can be previewed before they are disseminated and published. In accordance with another embodiment of the invention, the content can by directed to a personalization engine (FIGS. 1 and 3) before it is published to a live website or otherwise presented to users (presentation engine). The edited information can be thus used for updating content summaries on a website and/or user homepage, creating and updating Featured Topic and Topic Pages, selecting a set of articles for the content emails, RSS feeds and modifying premium item merchandising. It should be noted that the editorial systems herein can also modify content prior to dissemination to selected distribution partners of a media platform provider.

(4) Syndication Platform for Distributing Content to External Partners

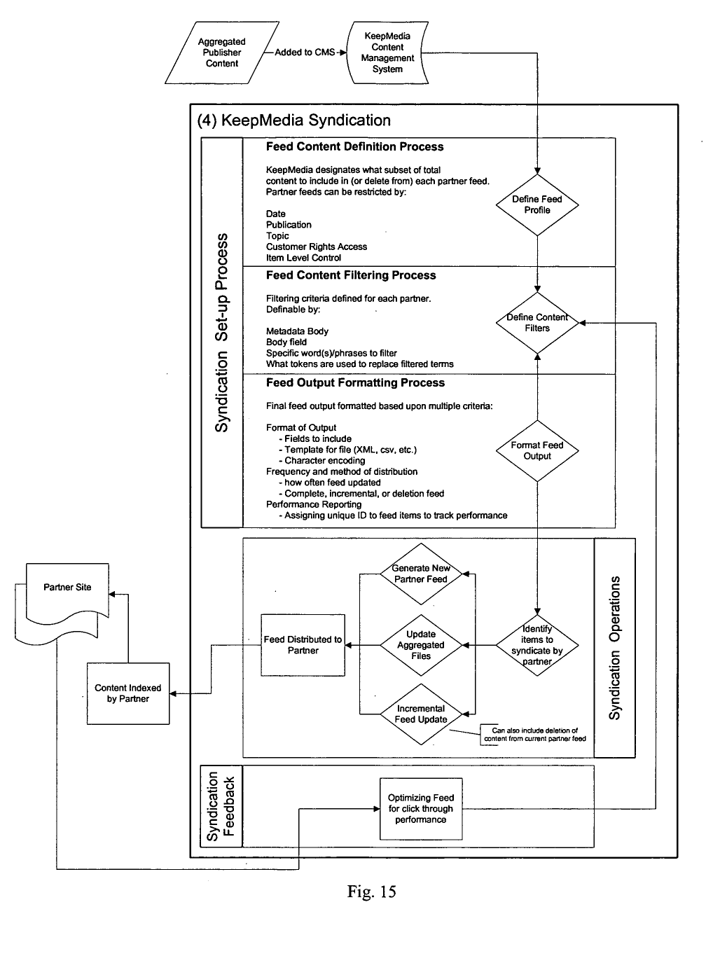

FIG. 15 illustrates another aspect of the invention that provides content syndication systems to a network of distribution partners for media platform providers such as KeepMedia. These syndication systems and related uses thereof can provide external partners with valuable exposure to the depth and range of content offered in the media libraries provided. At the same time, a new pool of users and prospective customers can be driven to the hosted websites through these external partners. In most instances, each item of content processed through a syndication system can be distributed to external distribution partners with a hyperlink or other facilitated connection which allows a user on partner websites to click through or access a hosted platform such as the KeepMedia website (FIG. 1). The syndication platforms provided herein can provide a critical way of generating new users to the services offered by the media platform provider.

The syndication platforms herein can selectively or automatically send out content or portions of content (i.e., summaries) to external partners through content feeds or otherwise made available through an application program interface (API) or specialized server pages designed to be readable by selected bots or web crawlers.

Content Feeds.

Content feeds are generated and accomplished preferably through a secured FTP site. FTP (file transfer protocol) is long established specification for transferring files over the Internet to and from remote computer systems. Usually a user transferring a file needs authority to login and access files on the remote system. Each partner can receive a separate secured feed which can be customized, filtered and displayed in a number of ways. These content feeds can be initialized and established by the syndication system through a series of set-up processes including but not limited to the following:

Feed Content Definition Process. The host of media platforms provided herein can elect or designate what subset of total process content items can be included or deleted from each partner feed. So after the processing and aggregation of content from publishers with other information related to supplemental articles and premium items, the content management system can pass-on content items to a syndication system according to defined content feed profiles. These partner content feeds can be individually set up with flexible parameters such as:

Frequency of distribution. The selected content items to partners can be distributed at different time intervals. Content can be regularly updated such as daily and weekly, or only as desired by the partner. The relevant cost and desired level of “freshness” of content will thus vary accordingly.

Format. The content feed for each distribution partner can be formatted according to individual needs and demands.

Feed Restrictions. The partner feeds can also be limited or restricted according to the date, the publication type and/or relevant topic of the processed contents from the content management system. According to a partner feed profile, certain rights of customers may be restricted so as to allow viewing of only certain content or portions of the media platform. It may be further possible to control the types and various levels of content sharing (low level sharing->high level sharing) to be permitted on partner sites.

Feed Content Filtering Process. A number of filtering criteria may be also separately selected and defined for each partner or groups of partners such as the following:

Word. Filters can be set up to automatically block (exclude) from a partner any feed content that includes particular words and/or phrases. Alternatively, the systems herein can remove the word(s), replace the word(s) or exclude the entire item from a partner feed.

Source. The filters can be also set-up to automatically block (exclude) from a partner feed any content derived from a particular source. These sources may be identified by partners ahead of time so they can limit or control to some degree the type of fed content according perhaps to the trustworthiness, dislike or preference of a particular media source.

Age. Filters can be set up to automatically block (exclude) from a partner feed content published during a predetermined time period. For instance, the filter could be set up to exclude content published more than 1 year ago. This type of temporal control allows partners to limit their access to certain information deemed to be stale, or to expand their abilities to access archived libraries of content.

Items. The filters selected during set-up of the content filtering can also be configured be automatically block (exclude) from a partner feed particular content items or groups of items. For instance, all content which is only sold on an individual items basis (i.e., not available through a website subscription) can be excluded from a partner feed. This type of flexibility allows a certain degree of freedom in establishing different subscription rates and pricing models so providers can exercise greater control for certain content on a per-item basis. Click-throughs to KeepMedia. Filters can be set up to monitor and automatically block (exclude) content items that result in undesirable types of click-throughs to the KeepMedia website. For instance, an article which generated a large number of click-throughs, but which did not generate a sufficient number of purchases on the KeepMedia website, could be automatically excluded from a feed. This may be critical since what sites such as KeepMedia pay its external partners may be based on click-throughs but the site may only generate revenue from purchases. In the past, merely getting visitors to a site had value when Web site traffic was generally accepted as a measure of success. But given the focus on profitability, the emphasis now is less interest on click-through rates and more on conversion rates. A high click-through rate does not assure a good conversion rate, and the two rates may even share an inverse relationship. Advertisements geared towards curiosity clicks will result in fewer, sales as opposed to those geared towards quality or qualified clicks. Accordingly, certain types of click-throughs may be excluded in accordance with this aspect of the invention when it is determined that no or little economic value to the website host is provided.

Other Filtering Options. Additionally, certain content may be filtered out according to certain types of data upon review of metadata corresponding to the content data an/or the body field of the content. It may be also possible replace terms filtered-out with “what” tokens. In some cases, an article may not actually have a particular term or word that is designated to be blocked or filtered e.g. adult content, but the metadata of the article or content item may have been tagged or otherwise identified as such. This filtering option thus allows searching through and filtering against the metadata of any content item in addition to the actual content body itself. This may be particularly relevant in instances with adult-tagged media or content that is non-text based media including video, audio, and thumbnail images.

Feed Output Formatting Process. The final partner feed can be output formatted based on certain pre-established criteria ahead of time such as the following:

Reporting. Customizable, detailed reporting can be set up to evaluation and monitor each individual feed or group of feeds. A unique identification or ID tag can be assigned to feed items to track performance of the feed to assist in performance reporting of the feed(s).

Verification. The system can be set up to check the XML output files to ensure the validity of the data and make certain automatic corrections if necessary.

Other Output Formatting. The format of the feed output can be varied and include certain fields while excluding others, set-up in accordance with a template for a file, and/or provided with character encoding. Depending on the type of platform a partner is running or otherwise supports, there may be a preferred or required format used that is only able to accept particular character encodings. For example, Linux/Unix based platforms would be UTF-8, Unicode, Windows—Western European (Windows), Latin 1, etc. At the same time, the frequency and method of content distribution can be changed as desired. The partner feed can be updated as often as frequently as the host/partner wants, and the feed provided can be a complete, incremental or deletion feed, or any combination of these types of feeds over a scheduled period of time.

Following set-up of the syndication systems provided herein, each of the items to be syndicated with each partner is identified and aggregated. Depending upon the type of feed, the content to be distributed is fed to the partner. A brand new partner feed can be generated with a new aggregation of content files, or a series of one or more aggregated files can be updated with only some additional content being added by the feed, or an incremental feed update with some new content, or deletion feed where certain content can be instructed to be removed from a current partner feed. Following distribution of content feeds to partners, the actual content may be indexed or further processed as desired by a partner before being published on partner websites.

A preferable embodiment of the invention provide apparatus and methods for setting-up and operating a syndication platform that distributes content to a network of external partners. The syndication platform may receive aggregated publisher content from content management systems provided herein. An initialization process may be performed to set-up the syndication and distribution of content feeds to the partners. This set-up process, may include (i) a feed content definition process; (ii) a feed content filtering process; and (iii) a feed output formatting process. The syndication platform may also include an operational set of processes wherein the content feeds to syndication partners are generated or updated in whole or in-part. Furthermore, the syndication platform and related methods of its use can incorporate a feedback loop that can optimize certain content distribution. For example, a series of click-throughs may be monitored for profitability and performance. During instances where a large number of click-throughs are identified as underperforming or not resulting in real gained revenue, they may be filtered out by the syndication platform.

Application Program Interface (API).

The media platform provided in accordance with the website allows external partners to set up their website systems to communicate with the websites such as the KeepMedia website in order to automatically present on their websites search results from queries submitted by their users. The API allows for various input parameters such as (i) number of results returned, (ii) by specific publication, (iii) the publication type; and (iv) restriction by item type (standard or premium item).

BotServer/Web Crawlers.

The media platform herein can also continuously monitor visits to hosted websites described herein such as the KeepMedia website. If the system detects a visit is being generated by an automated third-party bot (also known as a web crawler), the bot is directed to a dedicated content server or denied access to the system. This is important because most of the content on the KeepMedia website would not otherwise be available to these bots since it is behind a paywall. Portals and search engines such as Google and Yahoo can represent a significant portion of the overall activity on the Internet and these companies make extensive use of bots to index the available content on the Internet. It can be a critical function of systems such as the KeepMedia platform to be able to manage the content these bots have access to through its website. KeepMedia and other providers can also control which bots get access to the dedicated content server so that only approved bots are allowed to access stored system content.

(5) Contextual Presentation of Premium Items

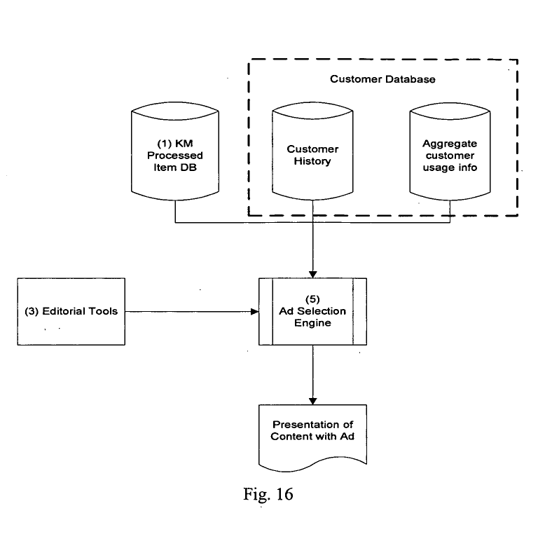

The media platforms provided herein can be designed to allow the merchandising of premium items that are related or tied to something users are doing or viewing on a website such as the KeepMedia website. This tactic and sales strategy is commonly known as cross-selling wherein premium items related to a certain article can be presented on part of the relevant Article Detail Page. Premium items can also be marketed on Topic Pages or with search results that may be reviewed in context the displayed user content. The relationship between premium items and user activity is generated automatically and can be more precisely tuned by specific user segment/profiles that can be obtained beforehand, and can also be controlled manually with editorial tools including those described herein. For example, as shown in FIG. 16, an advertising selection engine can receive information and data from the customer and content management systems and databases provided herein. The customer database will have relevant historical customer information that is useful for targeted and contextual presentation of premium items including where and what users view, keep, email, search, etc. In a preferable embodiment of the invention, methods are provided for targeting selected advertisements to users in combination with presented content items that are requested and/or suggested. The presentation of content and advertisements or ads can be modified by a set of editorial tools beforehand. The identification of particular ads can be based in whole or in-part on customer history information for a particular user and/or aggregate customer information that may identify related or most popular viewed content items. The specific information for each user can be compiled within the customer database to identify and provide aggregate customer information that may also provide useful data including most popular content items viewed, most searched topics and other general customer information. The editorial system and set of tools as described elsewhere herein can be selected to modify and effect editorial changes to the premium content advertised and promoted, and also the manner in which they are displayed or presented to users (FIG. 1). As a result, the selected user content can be then presented to users with desired advertising. It should be noted that the presentation of premium items using this form of targeted advertising can be considered a critical component to certain media platforms since it will often allow the media provider host to market premium items to one or more selected users of the website at a price or fee paid by retail partners.

While the invention has been described with reference to the aforementioned specification, the descriptions and illustrations of the preferable embodiments herein are not meant to be construed in a limiting sense. It shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art upon reference to the present disclosure. It is therefore contemplated that the appended claims shall also cover any such modifications, variations and equivalents.

1. A method for presenting electronically stored magazine content comprising:
selecting a plurality of magazine editions containing selected content of interest in each edition;
visually depicting each magazine edition on a graphical rack representation, wherein each magazine edition rests on the graphical rack representation as if displayed in a retail-store type arrangement;
enabling a user to click-on a selected magazine edition displayed on the graphical rack representation that brings the selected magazine edition to the forefront of the graphical rack representation to simulate taking the selected magazine edition off-the-rack, and wherein a plurality of links to the content of interest contained in the selected magazine edition are displayed thereafter for selection by the user; and
enabling the user to click-on a displayed link corresponding to the content of interest so the user can browse through the selected magazine edition.

2. The method for presenting electronically stored magazine content as recited in claim 1, wherein each magazine edition depicted is a thumbnail of the front cover to that edition.

3. The method for presenting electronically stored magazine content as recited in claim 1, wherein the plurality of magazine editions are different issues of the same publication.

4. The method for presenting electronically stored magazine content as recited in claim 1, wherein the plurality of magazine editions are different issues of different publications presented to the user.

5. The method for presenting electronically stored magazine content as recited in claim 4, wherein the different publications are preselected by the user.

6. The method for presenting electronically stored magazine content as recited in claim 4, wherein the different publications are predetermined based on a user history that tracks previously viewed content by the user.

7. The method for presenting electronically stored magazine content as recited in claim 1, wherein the content of interest provided to the user includes only a subset of content from the newsstand issue of the selected magazine edition in accordance with a subscription arrangement between the user and a media content provider that is presenting the stored magazine content.

8. The method for presenting electronically stored magazine content as recited in claim 1, wherein the selected magazine edition is for a publication in which the user has already purchased a print subscription through a media content provider that is presenting the stored magazine content, and wherein the content of interest provided to the user includes substantially the entire content from the newsstand issue of the selected magazine edition.

9. A graphical user interface for presenting media content comprising:
a series of pictorial images for selection by a user corresponding to a plurality of media publications containing content of interest; and
a graphical representation of a rack that is shown as supporting the series of pictorial images of the media publications resting on the graphical representation of the rack so that upon selection of a desired pictorial image, the selected pictorial image is brought to the forefront of the graphical rack representation to simulate taking a selected media publication off-the-rack, and a series of content links is presented corresponding to the content of interest contained in the selected media publication,
and wherein upon selection of a content link the graphical user interface presents the content of interest allowing the user to browse through the selected media publication.

10. The graphical user interface as recited in claim 9, wherein the interface automatically displays different issues of the same selected media publication for varying ranges of time periods.

11. The graphical user interface as recited in claim 9, wherein the series of pictorial images are thumbnails of the front covers to the media publications.

12. The graphical user interface as recited in claim 9, wherein content of interest is automatically selected for the user based on predefined featured items defined by a media content provider.

13. The graphical user interface as recited in claim 9, wherein content of interest is suggested content that is automatically selected for the user based on a user history that indicates potential interest in the suggested content.

14. The graphical user interface as recited in claim 9, wherein content of interest is suggested content that is automatically selected for the user based on content viewed by the user that falls within a common grouping by topic that includes the suggested content.

15. A method for presenting electronically stored media content comprising:
defining a plurality of publications containing selected media content of interest in each publication;
visually depicting each publication on a graphical rack representation, wherein each publication rests on the graphical rack representation so as to be displayed for browsing;
enabling a user to click-on a selected publication displayed on the graphical rack representation that brings the selected publication to the forefront of the graphical rack representation to simulate taking the selected publication off-the-rack, wherein a plurality of links to the content of interest contained in the selected publication are displayed thereafter for selection by the user; and
enabling the user to click-on a displayed link corresponding to the content of interest so the user can browse through the selected publication.

16. The method for presenting electronically stored media content as recited in claim 15, wherein the selected media content of interest is related to and based upon prior media content viewed by the user.

17. The method for presenting electronically stored media content as recited in claim 15, wherein the selected media content of interest is based upon selected feature topics predetermined by a media content provider.

18. The method for presenting electronically stored media content as recited in claim 15, wherein the plurality of publications may be presented on the graphical rack representation according to at least one of the following sequencing options or arrangements: chronologically by date of publication, alphabetically by publication name, defined user access rights in accordance with a subscription arrangement with a media content provider that is presenting the electronically stored media content, degree of frequency the publication is viewed, and the type of publication.

19. A computer readable medium having program code recorded thereon for presenting electronically stored media content on a graphical user interface, the program code causing a machine to perform the following method steps:
selecting a plurality of publications containing selected media content of interest in each publication;
visually depicting each publication on a graphical rack representation, wherein each publication rests on the graphical rack representation;
enabling a user to click-on a selected publication displayed on the graphical rack representation that brings the selected publication to the forefront of the graphical rack representation to simulate taking the selected publication off-the-rack, wherein a plurality of links to the content of interest contained in the selected publication are displayed thereafter for selection by the user; and
enabling the user to click-on a displayed link corresponding to the content of interest so the user can browse through the selected publication.
